(19) United States
(12) Patent Application Publication
(10) Pub. No.: US 2025/0123989 A1
(43) Pub. Date: Apr. 17, 2025

(54) OPTIMIZED TRANSMISSION AND BROADCASTING OF PRIORITY PACKETS AND CRITICAL EVENTS VIA UCIE-SIDEBAND

(71) Applicants: Swadesh CHOUDHARY, Mountain View, CA (US); Debendra DAS SHARMA, Saratoga, CA (US); Peter ONUFRYK, Flanders, NJ (US); Lakshmipriya SESHAN, Sunnyvale, CA (US)

(72) Inventors: Swadesh CHOUDHARY, Mountain View, CA (US); Debendra DAS SHARMA, Saratoga, CA (US); Peter ONUFRYK, Flanders, NJ (US); Lakshmipriya SESHAN, Sunnyvale, CA (US)

(21) Appl. No.: 19/000,434

(22) Filed: Dec. 23, 2024

Related U.S. Application Data
(60) Provisional application No. 63/682,976, filed on Aug. 14, 2024.

(51) Int. Cl. G06F 13/42

(52) U.S. Cl. CPC G06F 13/4221; G06F 2213/0026

(57) ABSTRACT

This disclosure describes systems, methods, and devices related to priority packet optimization. For example, a system is described for sideband communication in a universal chiplet interconnect express (UCIe) environment. The system may include a sideband link may include a clock pin and a data pin configured to transmit auxiliary signals between chiplets. The system may include an encoding module configured to generate level-based encodings representing global event notifications. The system may include a notification propagation module configured to distribute global event notifications across a network topology interconnecting the chiplets.

### CROSS-REFERENCE TO RELATED APPLICATION(S)

This application claims the benefit of U.S. Provisional Application No. 63/682,976, filed Aug. 14, 2024, the disclosure of which is incorporated herein by reference as if set forth in full

### BACKGROUND

Advancements in high-speed data transfer protocols are essential in meeting the growing needs of complex computing systems. The continuous evolution of connectivity standards is critical for enabling peak performance and reliability in data exchange. There is an inherent need to refine these protocols to support the efficient handling of data across advanced communication interfaces.

### BRIEF DESCRIPTION OF THE DRAWINGS

FIGS. 1-3 depict illustrative schematic diagrams for priority packet optimization, in accordance with one or more example embodiments of the present disclosure.

FIG. 4 depicts an illustrative schematic diagram for priority packet optimization, in accordance with one or more example embodiments of the present disclosure.

FIG. 5 illustrates a flow diagram of a process for a priority packet optimization system, in accordance with one or more example embodiments of the present disclosure.

FIG. 6 is a block diagram illustrating an example of a computing device or computing system upon which any of one or more techniques (e.g., methods) may be performed, in accordance with one or more example embodiments of the present disclosure.

FIG. 7 illustrates an embodiment of a block diagram for a computing system including a processor, in accordance with one or more example embodiments of the present disclosure.

FIG. 8 illustrates an example system implemented as system on chip (SoC), in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Universal Chiplet Interconnect Express (UCIe) is an industry standard pivotal in the evolution of integrated circuit design. It establishes protocols for chiplets—small blocks of integrated circuits—to interconnect within a single package. By leveraging standards like PCI Express (PCIe) and Compute Express Link (CXL), UCIe facilitates die-to-die serial connections that enable these chiplets to communicate effectively. The aim is to provide a scalable solution for creating larger, more complex System-on-Chips (SoCs) that go beyond the constraints of maximum reticle size. With UCIe, manufacturers gain the flexibility to combine chiplets from various sources, paving the way for more modular and easily upgradeable SoCs.

There is a need for low latency notifications over UCIe sideband (<100 ns) for things like thermal trip, power down or wake events, time synchronization, telemetry, security faults or debug triggers etc. The current behavior of UCIe sideband (which operates as a single data wire and clock running at 800 MHz) forces serialization of packets and since some packets can be as long as 512 b, the latency can be as high as 640 ns before the transmitter gets a chance to send another packet.

In one or more embodiments, a priority packet optimization system may define a mechanism to allow priority packets to be sent in the middle of another packet without resulting in aliasing (i.e. not relying on any specific pattern on the data lane).

For a System-in-Package (SiP), it is crucial to broadcast events such as thermal trips and security faults to all chiplets promptly. Standardizing this communication using UCIe sideband will enhance interoperability among the chiplets.

Typically, open-drain wires are used to transmit these events between chiplets. However, as the number of chiplets in a SiP increases, relying on ad-hoc wiring becomes problematic, affecting package routing, scalability, and interoperability.

Example embodiments of the present disclosure relate to systems, methods, and devices for transmitting priority packets over the UCIe sideband Link.

In one embodiment, a priority packet optimization system facilitates interrupting packets in flight at a 16 unit interval (UI) or multiple boundaries. This is achieved by sending a trigger on the clock lane, specifically through the absence of the clock pattern for a 4 UI interval. The receiver detects this absence and sets a flag to interpret future data transfers as a priority vector transfer.

Once the data transfers are completed, the transmitter sends another trigger on the clock lane, again using the absence of the clock pattern for a 4 UI interval, to inform the receiver that the original interrupted packet will resume. Different lengths of clock pattern absence, such as 4 UI or 8 UI, can serve as separate triggers for different types of data transfer patterns or indicate that the data lane will carry an analog event trigger.

This system offers several advantages. It avoids the need for dedicated bumps for these use cases, significantly reducing the GPIO count on chiplets. Additionally, it maintains low latency, even with ongoing traffic.

Additional example embodiments of the present disclosure relate to systems, methods, and devices for mechanisms to broadcast errors, power management (L2) exit, and other critical events using UCIe-sideband for a SiP.

A sequence of transitions and encodings on the clock and data pins of UCIe sideband to indicate different events like critical faults, power management (L2) exit. In combination with using long reach sideband Links, events could be broadcast to different chiplets in a SiP very rapidly either through direct connections or through daisy chaining.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

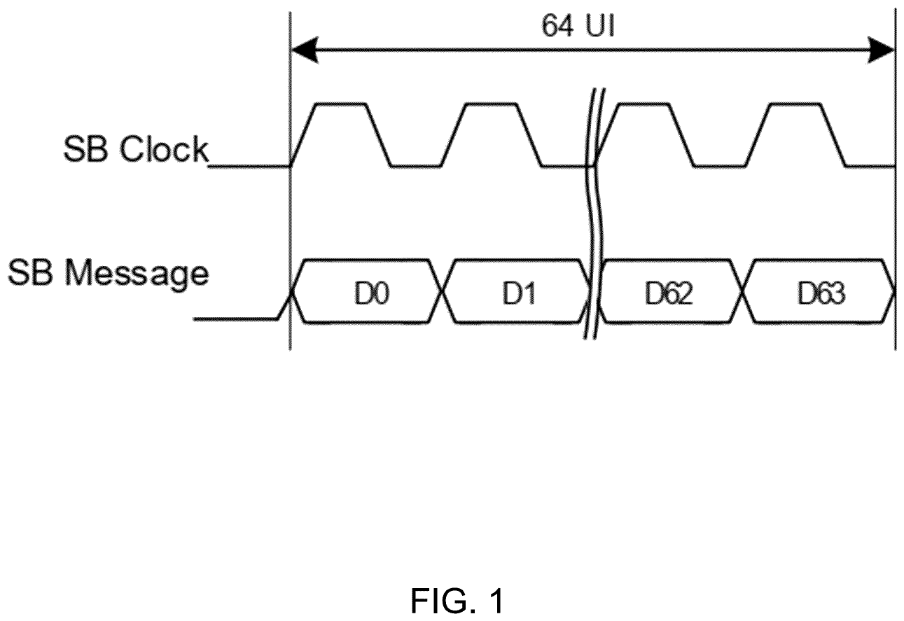

FIGS. 1-3 depict illustrative schematic diagrams for priority packet optimization, in accordance with one or more example embodiments of the present disclosure.

UCIe sideband works as a two-pin protocol with a clock and a data lane. Clock is idle if there is no data transfer.

FIG. 1 shows an example transfer of 64 UI of a sideband packet. Clock operates at a fixed frequency of 800 MHZ.

Currently, the maximum size of transfer for a packet over this Link is 512 bits. At a frequency of 800 MHZ, this is 640 ns of transmit time. an important property to utilize is that a 64 UI transfer is contiguous-there is no pausing the clock in the middle of a transfer currently in the UCIe.

In order to define a mechanism for priority transfer of low latency events, there will be three aspects:
1) A trigger from the transmitter to indicate it is switching to a high priority transfer. This trigger is in the form of the clock remaining 0 b (binary 0) for 4 UI before beginning the priority transfer. The receiver can implement a simple gray counter which increments on the received clock, and if the counter does not increment for a couple of cycles of the sampled domain while in the middle of a sideband packet, then it sets a flag to expect a priority transfer next. Other ways to implement receiver tracking can be used; an example has been given here to illustrate the concept.
2) The priority vector is sent from transmitter to receiver (in this example, this will be a 24 UI vector). The clock toggles and one data bit is transmitted per clock cycle.
3) A trigger from the transmitter is sent to indicate it is switching away from the high priority transfer and resuming the original packet (this is in the form of the clock remaining Ob for 4UI before resuming the original packet).

Note that the duration of the clock being Ob (4 UI or 8 UI or more) can be used to create different types of triggers if needed to further add different types of priority transfers (for example, if the notification needs to be sent as an analog transmission or an asynchronous trigger, this can be used to prepare the receiver to switch its sampler appropriate for the corresponding event type).

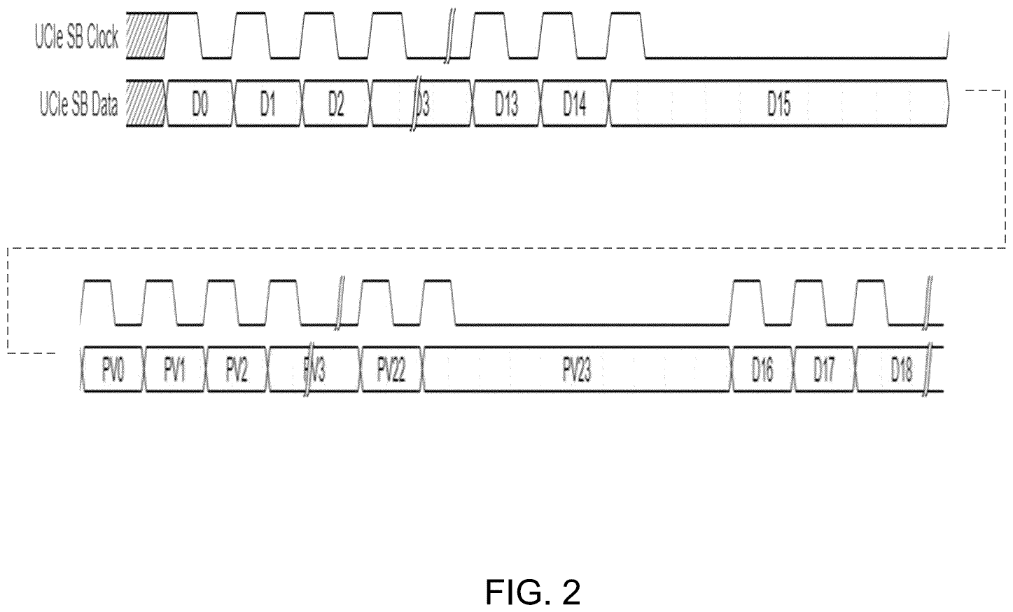

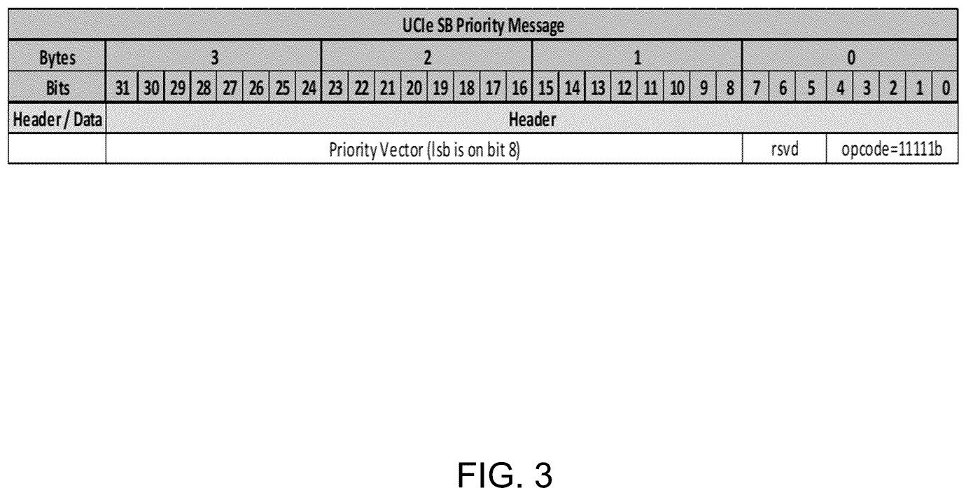

An example of this is shown in FIG. 2. The priority vector is represented by its individual bits, with PVi denoting the ith bit. The receiving Physical layer is responsible for formatting the priority vector into a UCIe sideband packet before forwarding it to the upper layers via the RDI configuration bus. The UCIe sideband packet structure, as illustrated in FIG. 3, includes fields such as the opcode and reserved bits, with routing handled implicitly based on the opcode. If the sideband link is idle when the transfer is initiated, the entire message, including the opcode and reserved fields, is transmitted. The Physical layer identifies that this is a 32-bit transfer by examining the opcode.

In one or more embodiments, the Physical layer ensures that the priority vector is correctly formatted as a UCIe sideband packet for efficient communication. The UCIe sideband packet includes fields that are essential for routing and error-checking, such as the opcode and reserved fields. For example, when transmitting a priority vector with PVi bits, the Physical layer appends the necessary fields, ensuring that the packet conforms to the UCIe sideband protocol for compatibility with upper-layer processing.

In one or more embodiments, when the sideband link is idle, the Physical layer transmits the full UCIe sideband packet, including all control fields like the opcode and reserved bits. This ensures that the packet contains all the information required for accurate routing and processing. For example, if the opcode specifies a 32-bit transfer, the Physical layer formats the message accordingly and forwards it, enabling the upper layers to process the priority vector without ambiguity or additional routing information.

In one or more embodiments, the opcode plays a crucial role in identifying the type and size of the transfer. For example, the Physical layer interprets the opcode to determine that the transmission is a 32-bit transfer and formats the packet accordingly. This implicit routing mechanism simplifies the packet structure by embedding routing information within the opcode, reducing the need for additional metadata.

Bit 23 of the priority vector is designated as a parity bit and is used to ensure data integrity by detecting errors during transmission. When the priority vector is transmitted independently, such as when it interrupts the transfer of another packet, the parity is calculated by performing an XOR operation across bits 22:0 of the priority vector. For example, if the binary sequence for bits 22:0 is 101010, the parity bit is computed so that the total number of 1s in the complete vector, including the parity bit, is even. If the full UCIe sideband priority message is transmitted, the parity computation includes an additional XOR operation that incorporates the reserved bits, which are unused or pre-allocated for future use, and opcode bits, which define the operations or instructions within the message. This ensures the parity check validates the integrity of both the active data fields and auxiliary control fields, safeguarding against errors in critical and supplementary parts of the message.

In one or more embodiments, the priority vector is configured to ensure reliable transmission through parity validation. The parity bit, located at bit 23, provides error-checking functionality by applying XOR operations across specified bits of the priority vector. For instance, when the vector operates in standalone mode, the parity ensures the integrity of bits 22:0 by maintaining an even count of binary 1s. This minimizes the likelihood of undetected errors during isolated packet transfers.

In one or more embodiments, when the priority vector is transmitted as part of a full UCIe sideband priority message, additional data fields are included in the parity computation. For example, the reserved and opcode bits in the message are incorporated into the XOR calculation. This extended parity computation enhances error detection by verifying the consistency of control signals and metadata alongside the primary priority vector bits, ensuring robust data integrity across complex transmission scenarios.

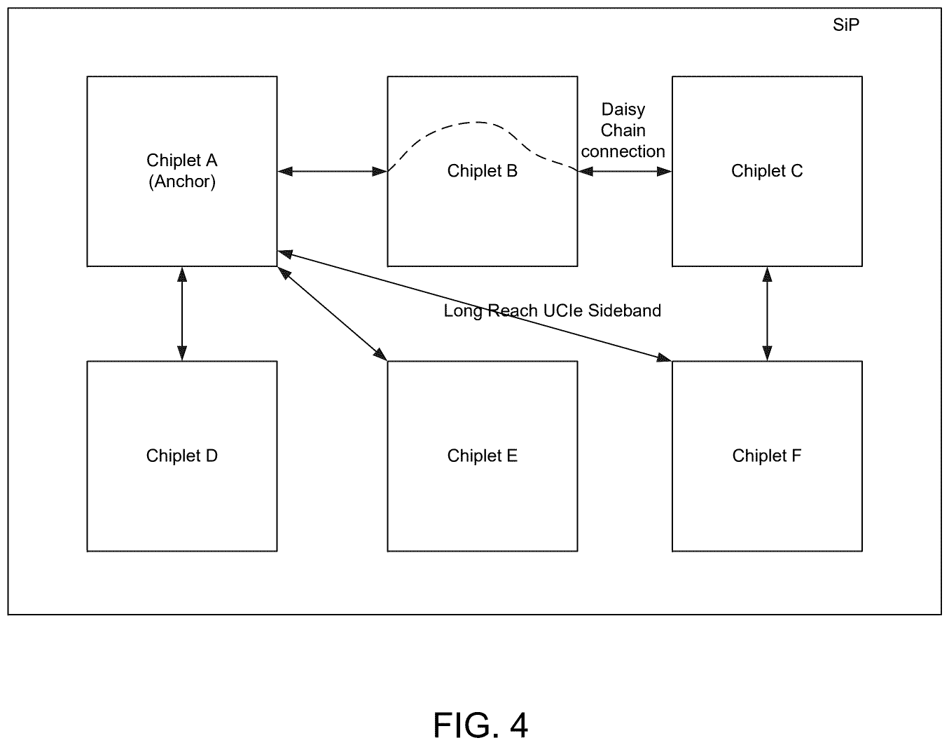

FIG. 4 depicts an illustrative schematic diagram for priority packet optimization, in accordance with one or more example embodiments of the present disclosure.

Referring to FIG. 4, there is shown example topology and connections of UCIe sideband only Links in a SiP.

In FIG. 4, different methods of using UCIe sideband links to connect various chiplets within a System-in-Package (SiP) are illustrated. UCIe 2.0 provides support for UCIe-sideband-only connections, allowing configurations that facilitate low-overhead, dedicated links for manageability, debugging, and error messaging. The figure also demonstrates a daisy chain connection between chiplets for these sideband communications. While the concepts apply to any topology or connectivity, the specific routing, encoding, or notification mechanisms within a chiplet are dependent on the design of the System-on-a-Chip (SoC).

In one or more embodiments, UCIe sideband links are employed to establish dedicated connections between chiplets for critical functions like system management and error handling. These sideband-only connections minimize resource usage while maintaining reliable communication pathways. For example, a sideband link in a SiP can be used to transmit debug information between a central SoC and multiple peripheral chiplets, ensuring that system diagnostics do not interfere with primary data channels.

In one or more embodiments, the daisy chain topology shown in FIG. 4 is used to connect chiplets in sequence, enabling scalable and efficient communication across the SiP. For example, in a three-chiplet system, a sideband link can propagate error messages from a peripheral chiplet through an intermediate chiplet to the SoC, simplifying the routing process. This topology also reduces the number of direct connections required, optimizing the SiP's layout and power consumption.

In one or more embodiments, the routing and encoding mechanisms within a chiplet are implemented to align with specific SoC requirements. For example, a chiplet may use a custom notification protocol for transmitting error events over the sideband link to ensure compatibility with its SoC's manageability subsystem. Such flexibility allows for the integration of diverse chiplets while leveraging the standardization provided by UCIe 2.0.

In the future, the UCIe sideband specification will be enhanced to permit longer reach sideband connections (>25 mm for standard package connectivity). This will permit configurations such as a star topology or any other topology within the SiP to optimize for latency critical notifications and avoid too many hops between any two chiplets. However, the encoding/notification idea presented here is applicable to any version of UCIe sideband (whether it accompanies a mainband or is a sideband only Link). A given UCIe sideband has a clock pin and a data pin. Clock=0 b and Data=0 b imply an idle Link.

Critical Error notification (such as a security fault or unrecoverable internal error/Viral): Clock=0 b and Data=1 b for >5 ns (the time of 5 ns is an example, any sufficiently large enough value of time could be used within the latency tolerance limits)—this constitutes a critical error notification. It is required for the transmitter to bring data=0 b after 1 us of being asserted to prevent the Link from being stuck in an unusable state. A chiplet is required to broadcast this to all its connected chiplets. This notification can occur in the middle of transmission of any sideband packet, and in that case, the corresponding partial sideband packet is discarded by the receiver and the transmitter must resend the packet after the sideband Link has gone back to idle. This notification can occur while a chiplet is in L2 and must serve as a trigger to wake up the chiplet infrastructure for appropriate error handling.

Thermal Trip notification: Clock=1 b and Data=1 b for >5 ns (the time of 5 ns is an example, any sufficiently large enough value of time could be used within the latency tolerance limits)—this constitutes a thermal trip notification to the receiving chiplet. A chiplet is required to broadcast this to all its connected chiplets and take appropriate actions to aggressively lower power consumption by throttling cores etc. This notification can occur in the middle of transmission of any sideband packet, and in that case, the corresponding partial sideband packet is discarded by the receiver and the transmitter must resend the packet after the sideband Link has gone back to idle.

Power management exit (L2 exit): L2 is the deepest available power state and it is possible for some chiplets to turn off their internal clock and voltage associated with the sideband/infrastructure logic. For example, where Chiplet A is trying to exit L2 on the Link to Chiplet B. Chiplet A sets Clock=1 b and Data=0 b is an indication to the receiving chiplet to start waking up its infrastructure voltage and clock (a minimum amount of detection logic for this condition needs to be powered on always, even when in L2). Once Chiplet B is ready to initialize sideband, it will assert Clock=1 b and Data=0 b on the sideband pins from Chiplet B to Chiplet A. If a chiplet observes Clock=1 b and Data=0 b on both its Transmitter and Receiver pins for more than 10 ns, it will go to idle conditions (i.e. Clock=0 b and Data=0 b). At this point the Sideband initialization can begin and subsequently any other sideband messages can be transmitted. Moreover, the mainband (if present) can begin to train as well.

It is understood that the above descriptions are for the purposes of illustration and are not meant to be limiting.

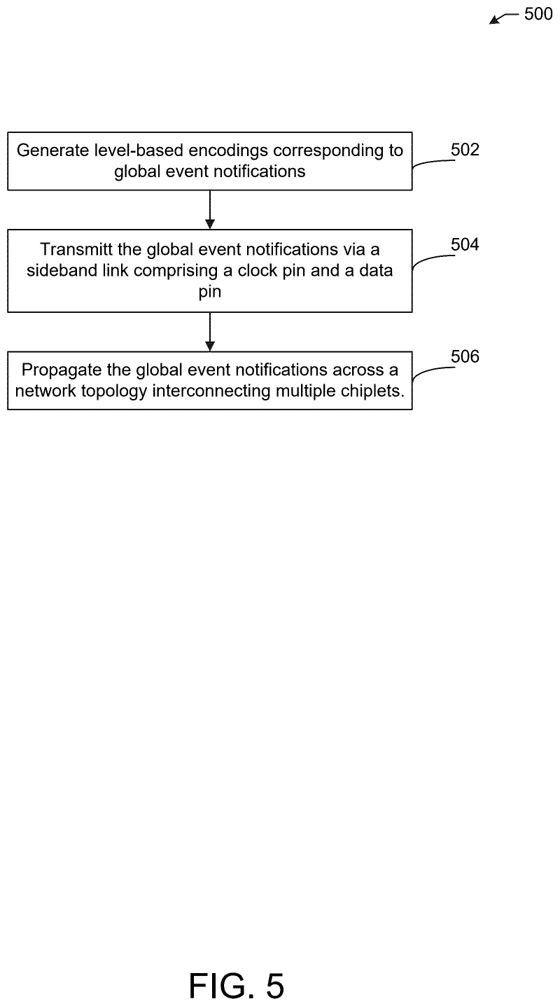

FIG. 5 illustrates a flow diagram of illustrative process 500 for a priority packet optimization system, in accordance with one or more example embodiments of the present disclosure.

At block 502, a device may generate level-based encodings corresponding to global event notifications.

At block 504, the device may transmit the global event notifications via a sideband link comprising a clock pin and a data pin.

At block 506, the device may propagate the global event notifications across a network topology interconnecting multiple chiplets.

In some embodiments, the device may define specific levels for error notifications, thermal trip events, and power management handshakes while generating the level-based encodings. The device may transmit the global event notifications without packetizing the notifications into higher-layer messages. The device may propagate the global event notifications using a daisy chain topology with intermediate chiplets relaying the notifications. The device may utilize the sideband link to achieve low-latency transmission using the clock pin and data pin. The device may interpret the level-based encodings at each chiplet to trigger chiplet-specific actions.

It is understood that the above descriptions are for the purposes of illustration and are not meant to be limiting.

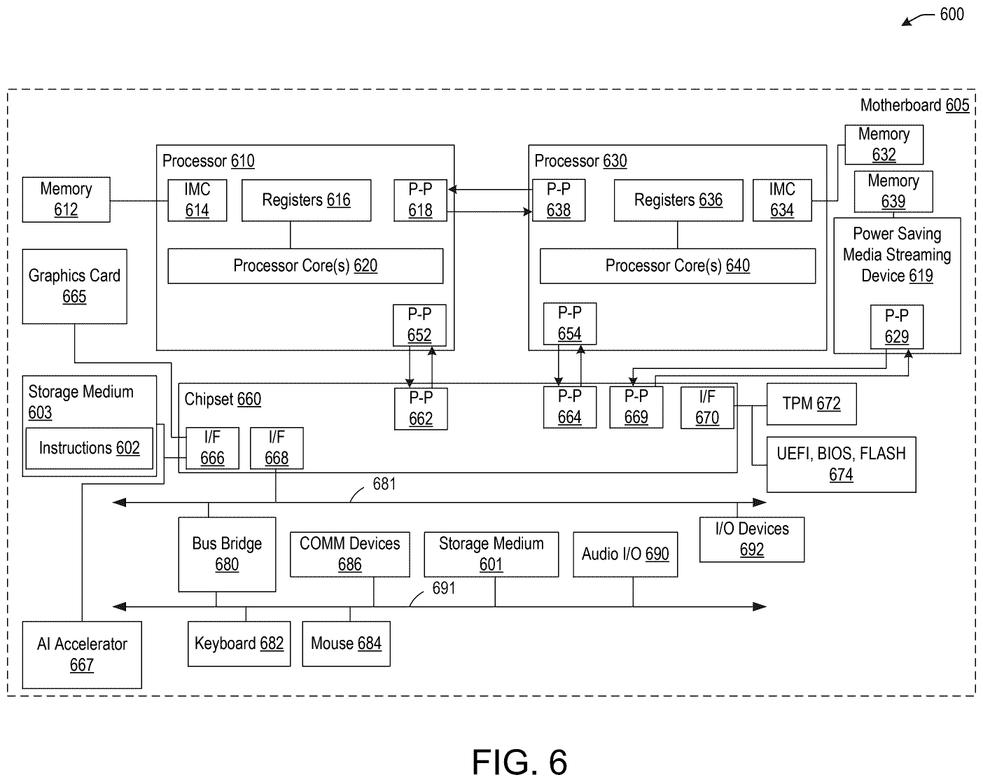

FIG. 6 illustrates an embodiment of an exemplary system 600, in accordance with one or more example embodiments of the present disclosure.

In various embodiments, the computing system 600 may comprise or be implemented as part of an electronic device.

The embodiments are not limited in this context. More generally, the computing system 600 is configured to implement all logic, systems, processes, logic flows, methods, equations, apparatuses, and functionality described herein.

The system 600 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 600 may have a single processor with one core or more than one processor. Note that the term “processor” refers to a processor with a single core or a processor package with multiple processor cores.

The computing system 600 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 600. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 600 comprises a motherboard 605 for mounting platform components. The motherboard 605 is a point-to-point interconnect platform that includes a processor 610, a processor 630 coupled via a point-to-point interconnects as an Ultra Path Interconnect (UPI), and a priority packet optimization device 619. In other embodiments, the system 600 may be of another bus architecture, such as a multi-drop bus. Furthermore, each of processors 610 and 630 may be processor packages with multiple processor cores. As an example, processors 610 and 630 are shown to include processor core(s) 620 and 640, respectively. While the system 600 is an example of a two-socket (2 S) platform, other embodiments may include more than two sockets or one socket. For example, some embodiments may include a four-socket (4 S) platform or an eight-socket (8 S) platform. Each socket is a mount for a processor and may have a socket identifier. Note that the term platform refers to the motherboard with certain components mounted such as the processors 610 and the chipset 660. Some platforms may include additional components and some platforms may only include sockets to mount the processors and/or the chipset.

The processors 610 and 630 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 610, and 630.

The processor 610 includes an integrated memory controller (IMC) 614, registers 616, and point-to-point (P-P) interfaces 618 and 652. Similarly, the processor 630 includes an IMC 634, registers 636, and P-P interfaces 638 and 654. The IMC's 614 and 634 couple the processors 610 and 630, respectively, to respective memories, a memory 612 and a memory 632. The memories 612 and 632 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 612 and 632 locally attach to the respective processors 610 and 630.

In addition to the processors 610 and 630, the system 600 may include a priority packet optimization device 619. The priority packet optimization device 619 may be connected to chipset 660 by means of P-P interfaces 629 and 669. The priority packet optimization device 619 may also be connected to a memory 639. In some embodiments, the priority packet optimization device 619 may be connected to at least one of the processors 610 and 630. In other embodiments, the memories 612, 632, and 639 may couple with the processor 610 and 630, and the priority packet optimization device 619 via a bus and shared memory hub.

System 600 includes chipset 660 coupled to processors 610 and 630. Furthermore, chipset 660 can be coupled to storage medium 603, for example, via an interface (I/F) 666. The I/F 666 may be, for example, a Peripheral Component Interconnect-enhanced (PCI-e). The processors 610, 630, and the priority packet optimization device 619 may access the storage medium 603 through chipset 660.

It should be noted that PCIe, UCIe, and CXL are distinct standards in computing, each serving specific functions. PCIe, or Peripheral Component Interconnect Express, is a widely adopted serial computer expansion bus standard. It is integral for connecting high-speed components such as graphics cards, SSDs, and network cards to a motherboard, known for its scalability and efficient data transfer rates. Its point-to-point configuration reduces bottlenecks, making it highly effective. In contrast, UCIe, or Universal Chiplet Interconnect Express, is a more recent development. It standardizes the interconnect between chiplets within a single package. Chiplets are small, modular silicon blocks with specific functions, assembled to form a complex chip. UCIe's primary aim is to streamline chiplet communication, fostering the design and creation of more efficient and powerful processors through modular integration. CXL, or Compute Express Link, focuses on high-speed, low-latency connections between CPUs and various devices like workload accelerators, memory buffers, and smart I/O devices. While leveraging the PCIe interface for its physical and electrical aspects, CXL is tailored for advanced computing tasks requiring intensive data processing, such as AI and machine learning. Its ability to efficiently share memory among various components is a key feature, marking its importance in the realm of data-intensive computing. Together, these technologies represent the diverse needs and advancements in computer hardware, from general expansion capabilities to specialized data processing and modular chip design. PCIe's established presence contrasts with the emerging roles of UCIe and CXL, highlighting the dynamic and evolving nature of computer technology.

Storage medium 603 may comprise any non-transitory computer-readable storage medium or machine-readable storage medium, such as an optical, magnetic or semiconductor storage medium. In various embodiments, storage medium 603 may comprise an article of manufacture. In some embodiments, storage medium 603 may store computer-executable instructions, such as computer-executable instructions 602 to implement one or more of processes or operations described herein, (e.g., process XZY00 of FIG. XZY). The storage medium 603 may store computer-executable instructions for any equations depicted above. The storage medium 603 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 610 couples to a chipset 660 via P-P interfaces 652 and 662 and the processor 630 couples to a chipset 660 via P-P interfaces 654 and 664. Direct Media Interfaces (DMIs) may couple the P-P interfaces 652 and 662 and the P-P interfaces 654 and 664, respectively. The DMI may be a high-speed interconnect that facilitates, e.g., eight Giga Transfers per second (GT/s) such as DMI 3.0. In other embodiments, the processors 610 and 630 may interconnect via a bus.

The chipset 660 may comprise a controller hub such as a platform controller hub (PCH). The chipset 660 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 660 may comprise more than one controller hub such as a chipset with a memory controller hub, a graphics controller hub, and an input/output (I/O) controller hub.

In the present embodiment, the chipset 660 couples with a trusted platform module (TPM) 672 and the UEFI, BIOS, Flash component 674 via an interface (I/F) 670. The TPM 672 is a dedicated microcontroller designed to secure hardware by integrating cryptographic keys into devices. The UEFI, BIOS, Flash component 674 may provide pre-boot code.

Furthermore, chipset 660 includes the I/F 666 to couple chipset 660 with a high-performance graphics engine, graphics card 665. In other embodiments, the system 600 may include a flexible display interface (FDI) between the processors 610 and 630 and the chipset 660. The FDI interconnects a graphics processor core in a processor with the chipset 660.

Various I/O devices 692 couple to the bus 681, along with a bus bridge 680 which couples the bus 681 to a second bus 691 and an I/F 668 that connects the bus 681 with the chipset 660. In one embodiment, the second bus 691 may be a low pin count (LPC) bus. Various devices may couple to the second bus 691 including, for example, a keyboard 682, a mouse 684, communication devices 686, a storage medium 601, and an audio I/O 690.

The artificial intelligence (AI) accelerator 667 may be circuitry arranged to perform computations related to AI. The AI accelerator 667 may be connected to storage medium 603 and chipset 660. The AI accelerator 667 may deliver the processing power and energy efficiency needed to enable abundant-data computing. The AI accelerator 667 is a class of specialized hardware accelerators or computer systems designed to accelerate artificial intelligence and machine learning applications, including artificial neural networks and machine vision. The AI accelerator 667 may be applicable to algorithms for robotics, internet of things, other data-intensive and/or sensor-driven tasks.

Many of the I/O devices 692, communication devices 686, and the storage medium 601 may reside on the motherboard 605 while the keyboard 682 and the mouse 684 may be add-on peripherals. In other embodiments, some or all the I/O devices 692, communication devices 686, and the storage medium 601 are add-on peripherals and do not reside on the motherboard 605.

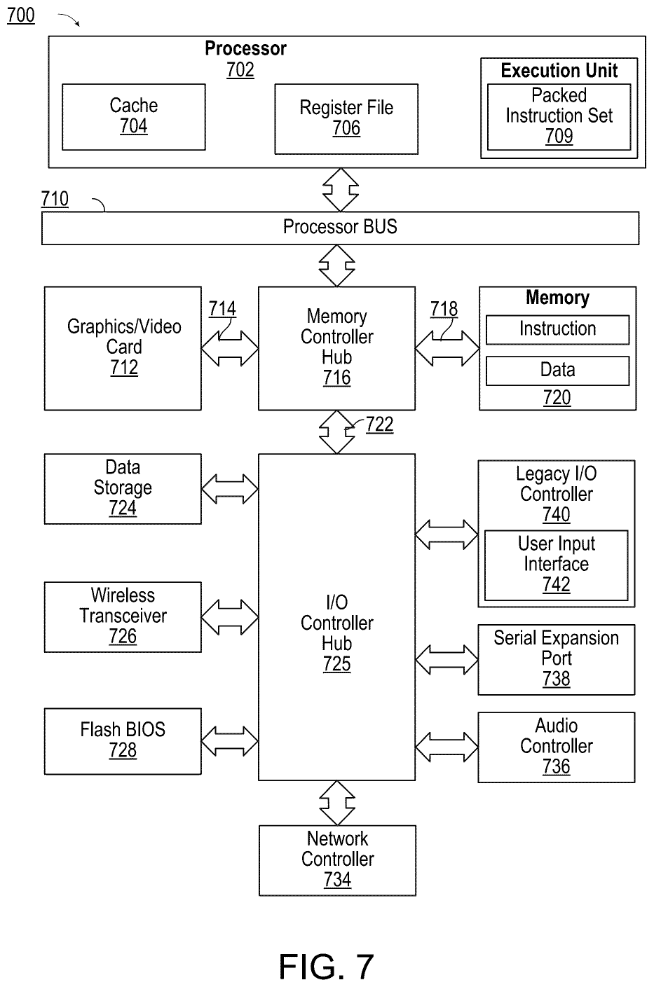

Turning to FIG. 7, a block diagram of an exemplary computer system formed with a processor that includes execution units to execute an instruction, where one or more of the interconnects implement one or more features in accordance with one embodiment of the present disclosure is illustrated. System 700 includes a component, such as a processor 702 to employ execution units including logic to perform algorithms for process data, in accordance with the present disclosure, such as in the embodiment described herein. In one embodiment, sample system 700 executes a version of an operating system and included software, and provides corresponding graphical user interfaces, may also be used. However, embodiments of the present disclosure are not limited to any specific combination of hardware circuitry and software.

Embodiments are not limited to computer systems. Alternative embodiments of the present disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 702 includes one or more execution units 708 to implement an algorithm that is to perform at least one instruction. One embodiment may be described in the context of a single processor desktop or server system, but alternative embodiments may be included in a multiprocessor system. System 700 is an example of a ‘hub’ system architecture. The computer system 700 includes a processor 702 to process data signals. The processor 702, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 702 is coupled to a processor bus 710 that transmits data signals between the processor 702 and other components in the system 700. The elements of system 700 (e.g. graphics accelerator 712, memory controller hub 716, memory 720, I/O controller hub 725, wireless transceiver 726, Flash BIOS 728, Network controller 734, Audio controller 736, Serial expansion port 738, I/O controller 740, etc.) perform their conventional functions that are well known to those familiar with the art.

In one embodiment, the processor 702 includes a Level 1 (L1) internal cache memory 704. Depending on the architecture, the processor 702 may have a single internal cache or multiple levels of internal caches. Other embodiments include a combination of both internal and external caches depending on the particular implementation and needs. Register file 706 is to store different types of data in various registers including integer registers, floating point registers, vector registers, banked registers, shadow registers, checkpoint registers, status registers, and instruction pointer register.

Execution unit 708, including logic to perform integer and floating-point operations, also resides in the processor 702. The processor 702, in one embodiment, includes a microcode (ucode) ROM to store microcode, which when executed, is to perform algorithms for certain macroinstructions or handle complex scenarios. Here, microcode is potentially updateable to handle logic bugs/fixes for processor 702. For one embodiment, execution unit 708 includes logic to handle a packed instruction set 709. By including the packed instruction set 709 in the instruction set of a general-purpose processor 702, along with associated circuitry to execute the instructions, the operations used by many multimedia applications may be performed using packed data in a general-purpose processor 702. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 708 may also be used in micro controllers, embedded processors, graphics devices, DSPs, and other types of logic circuits. System 700 includes a memory 720. Memory 720 includes a dynamic random access memory (DRAM) device, a static random access memory (SRAM) device, flash memory device, or other memory device. Memory 720 stores instructions and/or data represented by data signals that are to be executed by the processor 702.

Note that any of the aforementioned features or aspects of the present disclosure and solutions may be utilized on one or more interconnect illustrated in FIG. 7. For example, an on-die interconnect (ODI), which is not shown, for coupling internal units of processor 702 implements one or more aspects of the embodiments described above. Or the embodiments may be associated with a processor bus 710 (e.g. other known high performance computing interconnect), a high bandwidth memory path 718 to memory 720, a point-to-point link to graphics accelerator 712 (e.g. a Peripheral Component Interconnect express (PCIe) compliant fabric), a controller hub interconnect 722, an I/O or other interconnect (e.g. USB, PCI, PCIe) for coupling the other illustrated components. Some examples of such components include the audio controller 736, firmware hub (flash BIOS) 728, wireless transceiver 726, data storage 724, legacy I/O controller 725 containing user input and keyboard interfaces 742, a serial expansion port 738 such as Universal Serial Bus (USB), and a network controller 734. The data storage device 724 can comprise a hard disk drive, a floppy disk drive, a CD-ROM device, a flash memory device, or other mass storage device.

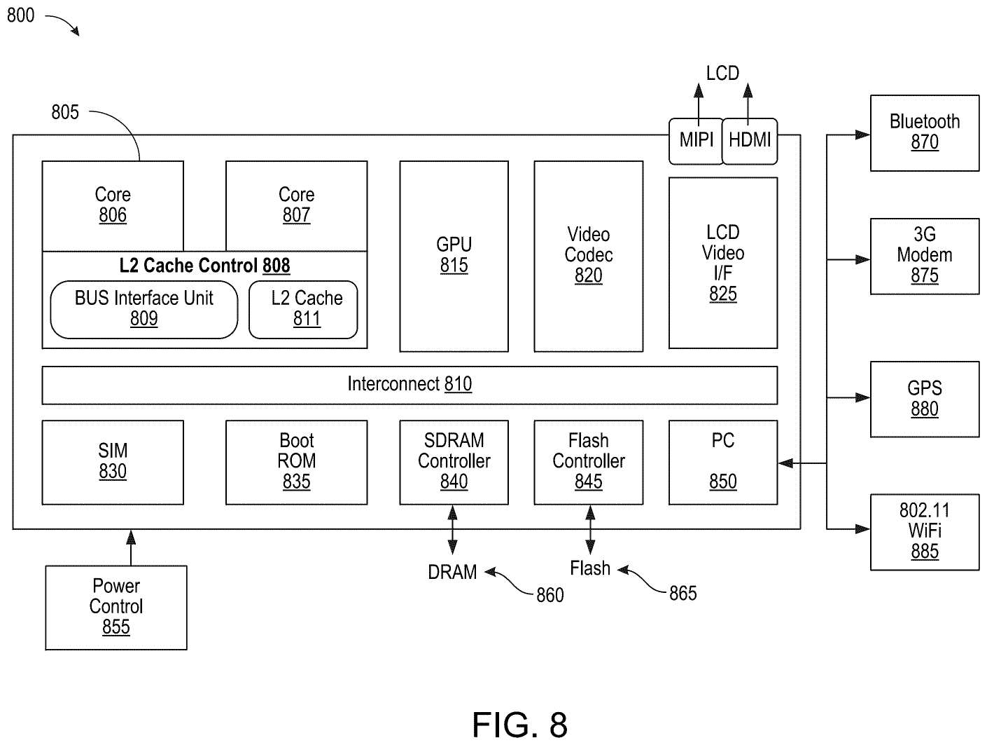

Turning next to FIG. 8, an embodiment of a system on-chip (SOC) design in accordance with the above disclosure is depicted. As a specific illustrative example, SOC 800 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 800 includes 2 cores—806 and 807. Similar to the discussion above, cores 806 and 807 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 806 and 807 are coupled to cache control 808 that is associated with bus interface unit 809 and L2 cache 811 to communicate with other parts of system 800. Interconnect 810 includes an on-chip interconnect, such as an IOSF, AMBA, or other interconnect discussed above, which potentially implements one or more aspects described herein.

Interconnect 810 provides communication channels to the other components, such as a Subscriber Identity Module (SIM) 830 to interface with a SIM card, a boot ROM 835 to hold boot code for execution by cores 806 and 807 to initialize and boot SOC 800, a SDRAM controller 840 to interface with external memory (e.g. DRAM 860), a flash controller 845 to interface with non-volatile memory (e.g. Flash 865), a peripheral control 850 (e.g. Serial Peripheral Interface) to interface with peripherals, video codecs 820 and Video interface 825 to display and receive input (e.g. touch enabled input), GPU 815 to perform graphics related computations, etc. Any of these interfaces may incorporate aspects of the embodiments described herein.

In addition, the system illustrates peripherals for communication, such as a Bluetooth module 870, 3G modem 875, GPS 880, and WiFi 885. Note as stated above, a UE includes a radio for communication. As a result, these peripheral communication modules are not all required. However, in a UE some form of radio for external communication is to be included.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The following examples pertain to further embodiments.

Example 1 may include a system comprising a sideband link including a clock pin and a data pin; an encoding module configured to generate level-based encodings representing global event notifications; and a notification propagation module configured to distribute the global event notifications across a network topology interconnecting multiple chiplets.

Example 2 may include the system of Example 1 and/or some other example herein, wherein the global event notifications include error notifications, thermal trip events, and power management handshakes.

Example 3 may include the system of Example 1 and/or some other example herein, wherein the network topology comprises one of a star topology or a daisy chain topology.

Example 4 may include the system of Example 1 and/or some other example herein, wherein the sideband link operates independently of the main data link's power state.

Example 5 may include the system of Example 1 and/or some other example herein, wherein the level-based encodings comprise four states, including an idle state.

Example 6 may include the system of Example 1 and/or some other example herein, wherein the notification propagation module ensures event delivery independent of bit errors in the sideband link.

Example 7 may include the system of Example 1 and/or some other example herein, wherein the sideband link's level-based encodings provide fault-tolerant communication for critical global events.

Example 8 may include an apparatus comprising a sideband interface including a clock pin and a data pin; an encoding circuit configured to transmit global event notifications using level-based encodings; and a control module configured to propagate the global event notifications across a network topology of interconnected chiplets.

Example 9 may include the apparatus of Example 8 and/or some other example herein, wherein the control module is configured to propagate notifications in a latency-optimized manner across the network topology.

Example 10 may include the apparatus of Example 8 and/or some other example herein, wherein the encoding circuit is configured to use level-based encodings to ensure robustness against bit errors.

Example 11 may include the apparatus of Example 8 and/or some other example herein, wherein the global event notifications are transmitted without initializing the main data link.

Example 12 may include the apparatus of Example 8 and/or some other example herein, wherein the network topology comprises one of a mesh, tree, butterfly, or torus structure.

Example 13 may include the apparatus of Example 8 and/or some other example herein, wherein the encoding circuit is configured to generate level-based encodings for global event notifications using a predetermined frequency.

Example 14 may include the apparatus of Example 8 and/or some other example herein, wherein the control module supports bidirectional propagation of global event notifications within the network topology.

Example 15 may include a method comprising: generating level-based encodings corresponding to global event notifications; transmitting the global event notifications via a sideband link comprising a clock pin and a data pin; and propagating the global event notifications across a network topology interconnecting multiple chiplets.

Example 16 may include the method of Example 15 and/or some other example herein, wherein generating the level-based encodings includes defining specific levels for error notifications, thermal trip events, and power management handshakes.

Example 17 may include the method of Example 15 and/or some other example herein, wherein transmitting the global event notifications occurs without packetizing the notifications into higher-layer messages.

Example 18 may include the method of Example 15 and/or some other example herein, wherein propagating the global event notifications includes using a daisy chain topology with intermediate chiplets relaying the notifications.

Example 19 may include the method of Example 15 and/or some other example herein, wherein the sideband link uses a clock pin and data pin to achieve low-latency transmission.

Example 20 may include the method of Example 15 and/or some other example herein, further comprising interpreting the level-based encodings at each chiplet to trigger chiplet-specific actions.

Example 21 may include one or more non-transitory computer-readable media comprising instructions to cause an electronic device, upon execution of the instructions by one or more processors of the electronic device, to perform one or more elements of a method described in or related to any of Examples 1-20, or any other method or process described herein.

Example 22 may include an apparatus comprising logic, modules, and/or circuitry to perform one or more elements of a method described in or related to any of Examples 1-20, or any other method or process described herein.

Example 23 may include a method, technique, or process as described in or related to any of Examples 1-20, or portions or parts thereof.

Example 24 may include an apparatus comprising: one or more processors and one or more computer-readable media comprising instructions that, when executed by the one or more processors, cause the one or more processors to perform the method, techniques, or process as described in or related to any of Examples 1-20, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for sideband communication in a Universal Chiplet Interconnect Express (UCIe) environment, comprising:
a sideband link comprising a clock pin and a data pin configured to transmit auxiliary signals between chiplets;
an encoding circuit configured to generate level-based encodings representing global event notifications; and
a notification propagation circuit configured to distribute global event notifications across a network topology interconnecting the chiplets.

2. The system of claim 1, wherein the global event notifications include at least one of error notifications, thermal trip events, and power management handshakes.

3. The system of claim 1, wherein the network topology comprises one of a star topology or a daisy chain topology.

4. The system of claim 1, wherein the sideband link operates independently of a power state of a main data link.

5. The system of claim 1, wherein the level-based encodings comprise four states, including an idle state.

6. The system of claim 1, wherein the notification propagation circuit ensures event delivery independent of bit errors in the sideband link.

7. The system of claim 1, wherein level-based encodings associated with the sideband link provide fault-tolerant communication for critical global events.

8. An apparatus for sideband communication in a Universal Chiplet Interconnect Express (UCIe) system, comprising:
a sideband interface including a clock pin and a data pin;
an encoding circuit configured to transmit global event notifications using level-based encodings; and
a controller configured to propagate global event notifications across a network topology of interconnected chiplets.

9. The apparatus of claim 8, wherein the controller is configured to propagate notifications in a latency-optimized manner across the network topology.

10. The apparatus of claim 8, wherein the encoding circuit is configured to use level-based encodings to ensure robustness against bit errors.

11. The apparatus of claim 8, wherein the global event notifications are transmitted over a dedicated secondary link, independent of the main data link initialization.

12. The apparatus of claim 8, wherein the network topology comprises one of a mesh, tree, butterfly, or torus structure.

13. The apparatus of claim 8, wherein the encoding circuit is configured to generate level-based encodings for global event notifications using a predetermined frequency.

14. The apparatus of claim 8, wherein the controller supports bidirectional propagation of global event notifications within the network topology.

15. A method for transmitting global event notifications in a Universal Chiplet Interconnect Express (UCIe) system, comprising:
generating level-based encodings corresponding to global event notifications;
transmitting the global event notifications via a sideband link comprising a clock pin and a data pin; and
propagating the global event notifications across a network topology interconnecting multiple chiplets.

16. The method of claim 15, wherein generating the level-based encodings includes defining specific levels for error notifications, thermal trip events, and power management handshakes.

17. The method of claim 15, wherein the global event notifications are transmitted over a dedicated secondary link, independent of the main data link initialization.

18. The method of claim 15, wherein propagating the global event notifications includes using a daisy chain topology with intermediate chiplets relaying the notifications.

19. The method of claim 15, wherein the sideband link uses a clock pin and a data pin to achieve low-latency transmission.

20. The method of claim 15, further comprising interpreting the level-based encodings at each chiplet to trigger chiplet-specific actions.
